(19) United States
(12) Patent Application Publication
(10) Pub. No.: US 2023/0406552 A1
(43) Pub. Date: Dec. 21, 2023

(54) JOINT CALIBRATION METHOD AND APPARATUS, ELECTRONIC DEVICE AND UNMANNED AERIAL VEHICLE

(71) Applicant: AUTEL ROBOTICS CO., LTD., Shenzhen (CN)

(72) Inventor: Yanfeng DANG, Shenzhen (CN)

(73) Assignee: AUTEL ROBOTICS CO., LTD., Shenzhen (CN)

(21) Appl. No.: 18/206,058

(22) Filed: Jun. 5, 2023

(30) Foreign Application Priority Data
Jun. 17, 2022 (CN) 202210693310.0

(51) Int. Cl. B64U 20/87; G06V 20/17

(52) U.S. Cl. CPC B64U 20/87; G06V 20/17

(57) ABSTRACT

Joint calibration methods implemented by an unmanned aerial vehicle and a server are disclosed. The server receives pose information of a detection radar from the unmanned aerial vehicle. The pose information includes a ground height and a pitch angle of the detection radar. The server determines target calibration parameters matching the pose information of the detection radar, and sends the target calibration parameters to the unmanned aerial vehicle. The unmanned aerial vehicle determines a spatial conversion relationship between the detection radar and an image acquisition device based on the target calibration parameters, and performs data fusion between the detection radar and the image acquisition device according to the spatial conversion relationship.

### CROSS-REFERENCE TO RELATED APPLICATIONS

This application claims priority of Chinese Patent Application No. 202210693310.0, filed on Jun. 17, 2022, entitled as “JOINT CALIBRATION METHOD AND APPARATUS, ELECTRONIC DEVICE AND UNMANNED AERIAL VEHICLE”, the entire contents of which are incorporated herein by reference for all purposes.

### TECHNICAL FIELD

The present disclosure relates to the field of data fusion technologies, and in particular, to a joint calibration method and apparatus, an electronic device and an unmanned aerial vehicle.

### BACKGROUND

With continuous development of electronic information technologies, more and more automation devices, for example, unmanned aerial vehicles, start to be widely used in various industries. A plurality of sensors of different types, for example, millimeter-wave radars and cameras are usually mounted on such automation devices. Such sensor devices have own advantages and characteristics and cooperate with each other to meet use requirements in various application scenarios.

How to fuse data (for example, millimeter-wave radar detection data and visual image data) acquired by a plurality of sensor devices mounted on an automation device so that the automation device can easily integrate different sensor devices is an urgent problem to be resolved currently.

### SUMMARY

The present disclosure provides a joint calibration method, a joint calibration apparatus, an electronic device, and an unmanned aerial vehicle, overcoming at least one part of defects of an existing data fusion method.

According to a first aspect, the present disclosure provides a joint calibration method, includes: obtaining and uploading pose information of a detection radar, the pose information including a ground height of the detection radar and a pitch angle of the detection radar; receiving target calibration parameters matching the pose information of the detection radar; determining a spatial conversion relationship between the detection radar and an image acquisition device based on the target calibration parameters, and performing data fusion between the detection radar and the image acquisition device according to the spatial conversion relationship.

According to a second aspect, the present disclosure provides a joint calibration method, receiving pose information of a detection radar, the pose information including a ground height of the detection radar and a pitch angle of the detection radar; obtaining a plurality of pieces of test coordinate data under the pose information; calculating and determining, through the test coordinate data, to-be-determined parameters in a preset spatial conversion function, where the preset spatial conversion function is configured to represent a spatial conversion relationship between the detection radar and an image acquisition device; and delivering the calculated and determined to-be-determined parameters.

According to a third aspect, the present disclosure provides a joint calibration apparatus, includes: a pose information obtaining module, configured to obtain and upload pose information of a detection radar, the pose information including a ground height of the detection radar and a pitch angle of the detection radar; a calibration parameter receiving module, configured to receive target calibration parameters matching the pose information of the detection radar; and a joint calibration module, configured to determine a spatial conversion relationship between the detection radar and an image acquisition device based on the target calibration parameters.

According to a fourth aspect, the present disclosure provides a controller, includes at least one processor and a memory communicatively connected to the at least one processor, the memory storing instructions executable by the at least one processor, the instructions being executed by the at least one processor, to cause the at least one processor to perform the foregoing joint calibration method.

According to a fifth aspect, the present disclosure provides a joint calibration apparatus, includes: a pose information receiving module, configured to receive pose information of a detection radar, the pose information including a ground height of the detection radar and a pitch angle of the detection radar; a test data obtaining module, configured to obtain a plurality of pieces of test coordinate data under the pose information; a to-be-determined parameter calculation module, configured to calculate and determine, through the test coordinate data, to-be-determined parameters in a preset spatial conversion function, where the preset spatial conversion function is configured to represent a spatial conversion relationship between the detection radar and an image acquisition device; and a parameter delivering module, configured to deliver the calculated and determined to-be-determined parameters.

According to a sixth aspect, the present disclosure provides a server, includes at least one processor and a memory communicatively connected to the at least one processor, the memory storing instructions executable by the at least one processor, the instructions being executed by the at least one processor, to cause the at least one processor to perform the foregoing joint calibration method.

According to a seventh aspect, the present disclosure provides an electronic device, includes at least one processor and a memory communicatively connected to the at least one processor, the memory storing instructions executable by the at least one processor, the instructions being executed by the at least one processor, to cause the at least one processor to perform the foregoing joint calibration method.

According to an eighth aspect, the present disclosure provides an unmanned aerial vehicle, includes: a body, a detection radar and an image acquisition device being hung on the body; arms, connected to the body; power apparatuses, disposed on the arms and configured to provide power for the unmanned aerial vehicle to fly; and a flight controller, disposed on the body and communicatively connected to the detection radar and the image acquisition device respectively, where the flight controller stores a preset calibration parameter set and is configured to perform the foregoing joint calibration method, to determine a correspondence between radar detection data of the detection radar and image data of the image acquisition device.

According to a night aspect, the present disclosure provides a system, includes the foregoing server and the foregoing unmanned aerial vehicle, where the server is communicatively connected to the unmanned aerial vehicle.

According to the joint calibration method provided in the embodiments of the present disclosure, calibration parameters can be corrected and updated correspondingly according to an attitude change (for example, changes of a ground height and a pitch angle) of a detection radar, which ensures accuracy of an obtained spatial conversion relationship and improves a data fusion effect of the detection radar and an image acquisition device.

According to the system provided in the embodiments of the present disclosure, through cooperation between a server and an unmanned aerial vehicle, accurate calibration parameters can be provided for data fusion of a detection radar and an image acquisition device while the real-time calculation is ensured.

### BRIEF DESCRIPTION OF THE DRAWINGS

One or more embodiments are exemplarily described with reference to the corresponding figures in the accompanying drawings and the descriptions are not to be construed as limiting the embodiments. Components in the accompanying drawings that have same reference numerals are represented as similar components and unless otherwise particularly stated, the figures in the accompanying drawings are not drawn to scale.

FIG. 1 is a schematic diagram of an application environment in accordance with some implementations of the present disclosure.

FIG. 2A is a schematic diagram of a coordinate system correspondence in accordance with some implementations of the present disclosure, which shows a solid geometric relationship between a detection radar coordinate system and a world coordinate system.

FIG. 2B is a schematic diagram of a coordinate system correspondence in accordance with some implementations of the present disclosure, which shows a situation in which an image acquisition device coordinate system is converted from a three-dimensional projection to a two-dimensional coordinate system.

FIG. 2C is a schematic diagram of a coordinate system correspondence in accordance with some implementations of the present disclosure, which shows a correspondence between a two-dimensional image coordinate system and a two-dimensional pixel coordinate system.

FIG. 3A is a method flowchart of a joint calibration method in accordance with some implementations of the present disclosure, which shows method steps performed by an unmanned aerial vehicle.

FIG. 3B is a method flowchart of a joint calibration method in accordance with some implementations of the present disclosure, which shows method steps performed by a server.

FIG. 4 is a method flowchart of obtaining a preset spatial conversion function in accordance with some implementations of the present disclosure.

FIG. 5 is a schematic diagram of a calibration parameter set in accordance with some implementations of the present disclosure, which shows a calibration parameter table that records a plurality of groups of calibration parameters and matched pose information intervals.

FIG. 6 is a schematic diagram of information interaction of an unmanned aerial vehicle and a server in accordance with some implementations of the present disclosure.

FIG. 7A is a functional block diagram of a joint calibration apparatus in accordance with some implementations of the present disclosure, which shows an apparatus configured to perform the method steps in FIG. 3A.

FIG. 7B is a functional block diagram of a joint calibration apparatus in accordance with some implementations of the present disclosure, which shows an apparatus configured to perform the method steps in FIG. 3B.

FIG. 8 is a schematic diagram of an electronic device in accordance with some implementations of the present disclosure.

### DETAILED DESCRIPTION

For ease of understanding the present disclosure, the present disclosure is described in further detail below with reference to the accompanying drawings and specific embodiments. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. In the description of this specification, orientation or position relationships indicated by terms such as “up”, “down”, “inside”, “outside” and “bottom” are based on orientation or position relationships shown in the accompanying drawings and are merely used for ease of description of the present disclosure and for brevity of description, rather than indicating or implying that the mentioned apparatus or element needs to have a particular orientation or needs to be constructed and operated in a particular orientation, and therefore should not be understood as a limitation on the present disclosure. In addition, terms such as “first”, “second” and “third” are used only for description purpose and shall not be construed as indicating or implying relative importance.

Unless otherwise defined, meanings of all technical and scientific terms used in this specification are the same as that usually understood by a person skilled in the technical field to which the present disclosure belongs. Terms used in the specification of the present disclosure are merely intended to describe objectives of the specific embodiments, but are not intended to limit the present disclosure. A term “and/or” used in this specification includes any or all combinations of one or more related listed items.

In addition, technical features involved in different embodiments of the present disclosure described below may be combined together if there is no conflict.

A “millimeter-wave radar” is a detection radar that works in a millimeter-wave band. The millimeter-wave radar has strong penetrating power and can penetrate severe weather such as heavy rain, heavy snow and strong sand and dust. The millimeter-wave radar can also accurately detect weak and small targets in scenarios, for example, degradation of a visual effect caused by a light-intensive environment and a night vision condition. In this way, a problem that an automation device (for example, an unmanned aerial vehicle) suffers from low visibility and degraded sensing under severe conditions is resolved and a space situational sensing capability is enhanced. In the present disclosure, an example of the millimeter-wave radar is used for description in detail. A person skilled in the art may understand that a detection radar of another different type may alternatively be used.

An “image acquisition device” is a sensor (for example, an action camera or video camera) that senses light signals in a target area and obtains visual image data from the target area. The image acquisition device has low costs and has advantages in object height and width measurement accuracy and contour recognition and pedestrian recognition accuracy, and therefore is an indispensable sensor for implementing target classification, logo recognition and the like.

Usually, radar detection data and visual image data are fused to make advantages of two sensors complement each other, to establish a multifunctional control system with capabilities such as sensor fusion sensing, threat terrain warning, threat obstacle highlighting, and assisted flight, to realize an all-day, all-weather and all-terrain all-scenario environmental sensing capability of an operator of the unmanned aerial vehicle and provide enough time for timely avoidance of dangerous terrain and obstacles, thereby ensuring safe flight of the unmanned aerial vehicle under any air condition.

“Joint calibration” is a process of determining coordinate conversion relationships among a plurality of different coordinate systems. The joint calibration is used for establishing a correspondence between multi-source data (for example, the radar detection data and the visual image data) and can make the data converted between different coordinate systems, and therefore is a premise of implementing data fusion.

In a traditional joint calibration process of millimeter-wave radar detection data and image data, adopted data models are all established on the basis of a two-dimensional plane, without considering height-related information of the millimeter-wave radar. However, in some specific use scenarios (for example, the millimeter-wave radar is mounted on the unmanned aerial vehicle), the millimeter-wave radar may change in height, pitch angle, and the like with a flight attitude of the unmanned aerial vehicle. The pitch angle may be an included angle between a radar normal direction and a horizontal direction when the millimeter-wave radar works.

Therefore, the traditional data models based on the two-dimensional plane cannot well adapt to such use scenarios. When the attitude of the unmanned aerial vehicle changes, a data model thereof fails, resulting in a problem that there is a large deviation in depth information and the like because the radar detection data cannot be accurately converted and projected to a coordinate system of the visual image data.

The applicant found that, by establishing a data entry model based on three-dimensional space, the attitude change of the unmanned aerial vehicle can be adapted without losing data information of the millimeter-wave radar in the height and the pitch angle. By providing calibration parameters that change with the height and the pitch angle, data fusion between the radar detection data and the visual image data can be well implemented.

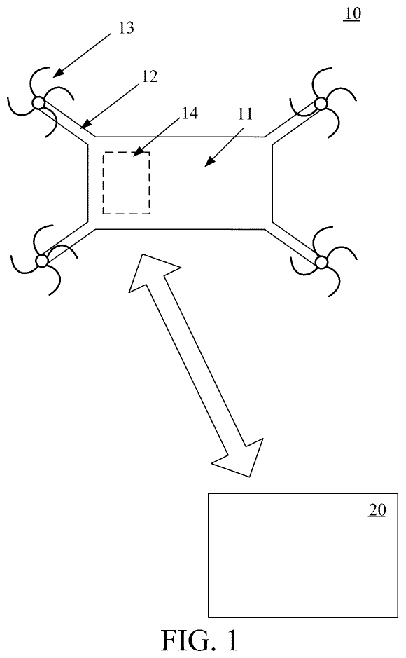

FIG. 1 is a schematic diagram of an application environment according to an embodiment of the present disclosure. The application environment uses a system formed by networking of an unmanned aerial vehicle and a server as an example. As shown in FIG. 1, the system may include a plurality of unmanned aerial vehicles 10 and a server 20.

The unmanned aerial vehicle 10 may include: a body 11, arms 12, power apparatuses 13 and a flight controller 14.

The body 11 is a main structure of the unmanned aerial vehicle 10. The body 11 has a suitable volume and shape that meet the needs of an actual situation, to provide enough space for accommodating one or more functional modules and components. For example, a plurality of different sensor devices, including but not limited to a detection radar and an image acquisition device, may be disposed on the body 11.

In some embodiments, a gimbal that can adjust an inclination angle or another similar structural apparatus may be further disposed on the abdomen of the body. Both the detection radar and the image acquisition device are mounted and fixed on the gimbal, so that pitch angles of the detection radar and the image acquisition device can be easily adjusted correspondingly according to a flight height of the unmanned aerial vehicle.

In some other embodiments, the sensor devices may further include a height finder radar. The height finder radar is a sensor device configured to accurately detect a ground height of the unmanned aerial vehicle. In some embodiments, the height finder radar may be an accurate distance detection apparatus of any suitable type, for example, a millimeter-wave radar. Certainly, at the expense of some accuracy, another similar sensor device such as an altimeter may alternatively be used to detect a current ground height of the unmanned aerial vehicle.

The arms 12 are parts of the body extending outward and are used as mounting or fixing structures of the power apparatuses, for example, propellers of the unmanned aerial vehicle. The arms may be integrally formed with the body or may be connected to the body in a detachable connection form. Typically, on a four-axis unmanned aerial vehicle, there may be four arms extending symmetrically along diagonals to form mounting positions of four propellers.

The power apparatuses 13 are structural apparatuses configured to provide power for the unmanned aerial vehicle to fly. In some embodiments, the power apparatuses may adopt power and structural design of any suitable type, for example, propellers that are driven by motors and are respectively mounted and fixed on mounting positions of tail ends of the arms.

The flight controller 14 is an unmanned aerial vehicle control core built in the body. The flight controller 14 may be an electronic device of any type with suitable logical judgment and computing capabilities, including but not limited to a processor chip implemented based on large-scale integrated circuits, an integrated system-on-chip (SOC), and a processor and a storage medium that are connected via a bus. Based on functions (for example, performing a joint calibration method provided in the embodiments of the present disclosure) to be implemented, the flight controller 14 may include a plurality of different functional modules. Such functional modules may be software modules, hardware modules, or modular apparatuses that combine software and hardware and are configured to implement one or more functions.

The server 20 is an electronic computing platform of any suitable type that can provide significantly greater computing performance and storage capacity than the flight controller 14. A specific implementation or deployment of the server 20 is not limited in the embodiments of the present disclosure, which may include but is not limited to a cloud server, an edge server, or a server or a server cluster of another suitable type.

The server 20 is remotely deployed outside the unmanned aerial vehicle 10 and can establish a communication connection with the flight controller 14 of the unmanned aerial vehicle 10 through a wireless communication of any suitable type to implement data transmission between the two. The communication connection may be an indirect communication connection or a direct communication connection, as long as data interaction between the server 20 and the unmanned aerial vehicle 10 can be implemented.

It should be noted that the embodiments of the present disclosure exemplarily demonstrate an application scenario of the joint calibration method for sake of simplicity. A person skilled in the art may also adjust one or more devices in the application scenario shown in FIG. 1, without being limited to what is shown in FIG. 1. For example, a relay base station is deployed between the server 20 and the unmanned aerial vehicles 10. The plurality of unmanned aerial vehicles 10 may be controlled by one relay base station and communication connections between the server and the unmanned aerial vehicles are implemented via the relay base station.

A person skilled in the art may understand that, based on a similar principle, the joint calibration method provided in the embodiments of the present disclosure may alternatively be applied to another application scenario in which a height and a pitch angle of the millimeter-wave radar may change. The inventive idea disclosed in the embodiments of the present disclosure is not limited to the application scenario shown in FIG. 1.

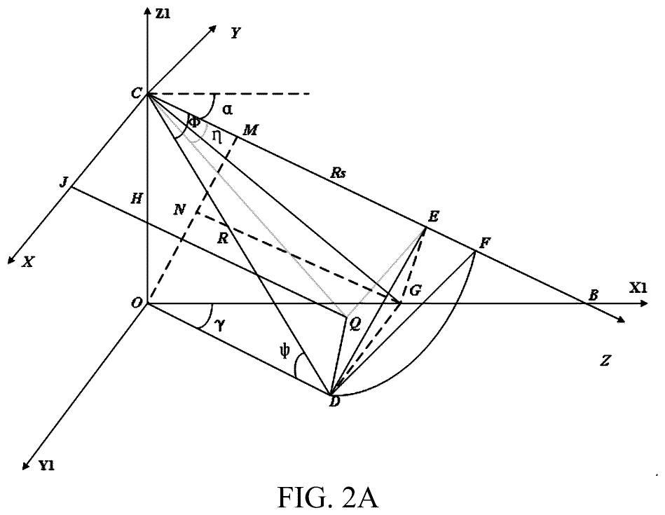

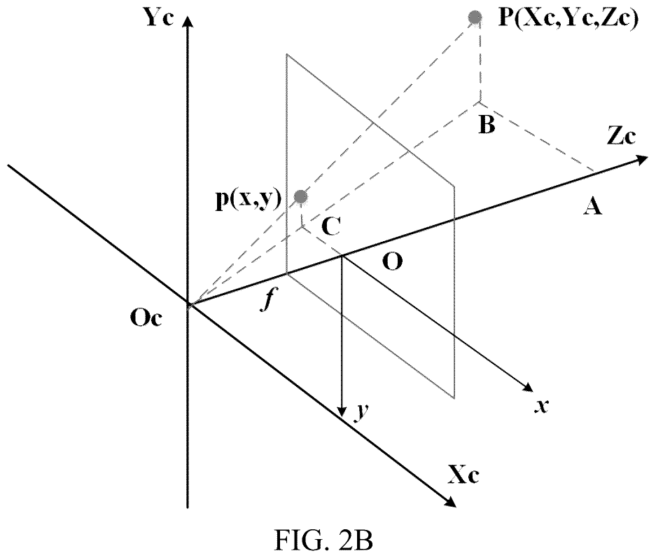

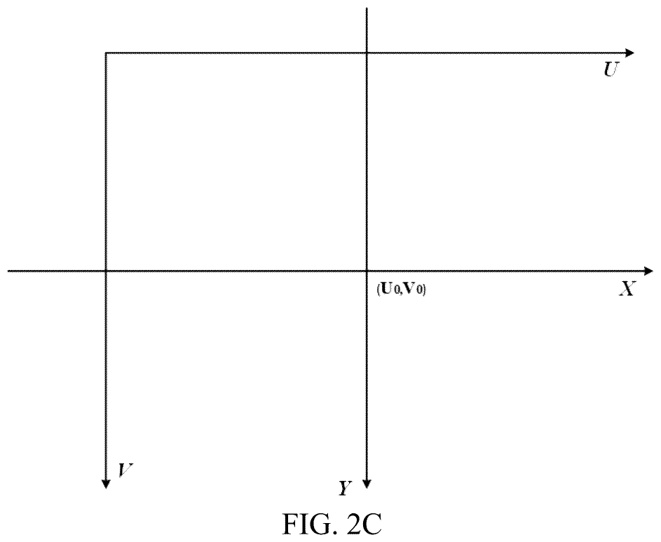

To fully describe a specific application process of the joint calibration method provided in the embodiments of the present disclosure in an application scenario shown in FIG. 1, construction of an instance of a data entry model based on three-dimensional space is described in detail below with reference to FIG. 2A to FIG. 2C. In this specific instance, the data entry model describes coordinate conversion relationships among a detection radar coordinate system, an image acquisition device coordinate system, a two-dimensional image coordinate system and a two-dimensional pixel coordinate system.

The detection radar coordinate system is a three-dimensional coordinate system that takes a phase center of a transmit antenna as a coordinate origin and meets a right-hand rule. The image acquisition device coordinate system is a three-dimensional coordinate system that takes an optical center of a device as a coordinate origin and meets the right-hand rule. The two-dimensional pixel coordinate system is a two-dimensional coordinate system that takes an upper left corner of an image plane as a coordinate origin, discretized pixels being on coordinate axes. The two-dimensional image coordinate system takes a center of an imaging plane (for example, CCD) as a coordinate origin, coordinate axes thereof being respectively parallel to the coordinate axes of the two-dimensional pixel coordinate system.

First, FIG. 2A is a schematic diagram of a solid geometric relationship between a detection radar coordinate system and a world coordinate system according to an embodiment of the present disclosure, which shows the solid geometric relationship between the detection radar coordinate system and the world coordinate system when a millimeter-wave radar is in a specific height and a specific inclination angle with flight of an unmanned aerial vehicle.

As shown in FIG. 2A, D is any point (for example, a detection target) in the three-dimensional space. A coordinate origin of the world coordinate system is O and three coordinate axes thereof are represented as X1, Y1 and Z1 respectively. A coordinate origin of the detection radar coordinate system is C and three coordinate axes thereof are represented as X, Y and Z respectively.

A ground height of a detection radar is H and a pitch angle of the detection radar is a (that is, an included angle between a radar normal direction and a horizontal direction when the millimeter-wave radar works). A distance between the millimeter-wave radar and D is R, Rs is a center slope distance of the millimeter-wave radar, an instantaneous azimuth angle of D relative to the millimeter-wave radar is γ and an instantaneous pitch angle of D relative to the millimeter-wave radar is w. When the detection radar adopts a one-dimensional linear MIMO array for angle detection, a target horizontal angle between the detection radar and D is θ_{radar}.
1) In FIG. 2A, a straight line DG perpendicular to OB may be drawn through D and a straight line GE perpendicular to CB may be drawn through G. It may be determined that DE is perpendicular to BC combined with three perpendicular line theorems. In a plane formed by points B, C and J, DQ perpendicular to the plane BCJ is drawn. Through such auxiliary line segments, it may be determined that three-dimensional coordinates of D in the detection radar coordinate system may be D=[DG, −GE, CE].
2) Radar detection data of the millimeter-wave radar for D mainly includes a distance between the radar and D and the target horizontal angle between the radar and D. In some embodiments, a calculation and detection process of the two pieces of radar detection data is as follows.
2.1) For the distance R, by using a frequency modulated continuous wave (FMCW) radar as an example, the millimeter-wave radar may transmit a FMCW signal. A frequency of the FMCW signal may change linearly in each frequency modulation cycle. When a reflected echo signal is received, digital down-conversion may be first performed on the reflected echo signal, then sample values are sorted into a two-dimensional matrix and then a time-domain echo signal is transformed into a frequency-domain dimension through two-dimensional (2-D) fast Fourier transform (FFT), to obtain a two-dimensional Doppler matrix (RDM) corresponding to a to-be-detected target and obtain a target distance R of the to-be-detected target combined with a constant false alarm detection (CFAR) algorithm.
2.2) For the target horizontal angle, by using a two-dimensional DOA (Direction Of Arrival) estimation algorithm as an example, a specific detection process is as follows.

It is assumed that for D, there is a radar array formed by N antennas and an antenna element distance is that d=λ/2, λ being a wavelength. It is assumed that an angle position of D relative to the radar in the three-dimensional space is (γ, ψ), that γϵ(−π/2, π/2) and that ψϵ(0, π/2) respectively representing an instantaneous azimuth angle and an instantaneous pitch angle corresponding to any point target. In this case, a signal vector s for estimating a direction of arrival (DOA) may be represented by the following formula (1-1):

s=A·α(γ,ψ) (1-1)

A represents a scattering coefficient of any point target. α(γ, ψ) represents a signal steering vector and may be represented by the following formula (1-2):

α(γ,ψ)=[1,e^{-j2πdsinγcosψ/λ}, . . . e^{-j2π(N-1)dsinγcosψ/λ}]^{H} (1-2)

For one-dimensional DOA estimation, a steering vector only considering an azimuth angle may be represented as:

b=[1,e^{-j2π sin γ/λ}, . . . e^{-j2π(N-1)dsinγ/λ}]^{H} (1-3)

Therefore, an azimuth estimation angle may be obtained by using the following formula (1-4):

$${\hat{γ}}_{traditional} = arg {max}_{γ} \vert {b}^{H} s \vert \qquad ( 1 - 4 )$$

After the target distance R and a target height difference H are determined, as shown in FIG. 2A, the instantaneous pitch angle between the detection radar and the any point target D may be represented by the following formula (1-5):

$$\hat{ψ} = a sin ( \frac{H}{R} ) \qquad ( 1 - 5 )$$

Therefore, it is considered that an azimuth steering vector corresponding to a pitch angle caused by a height may be represented by the following formula (1-6):

α(γ,\hat{ψ})=[1,e^{-j2πdsinγcos\hat{ψ}/λ}, . . . e^{-j2π(N-1)dsinγcos\hat{ψ}/λ}]^{H} (1-6)

d is an even antenna element distance, N is a quantity of receive antennas and [ ]^{H} represents a transposed conjugate of a matrix. In this case, through the DOA estimation, the target horizontal angle is obtained as:

$${θ}_{radar} = arg {max}_{γ} \vert {a}^{H} ( γ , \hat{ψ} ) s \vert \qquad ( 1 - 7 )$$

3) With reference to the steering vector expression derived through the foregoing steps, when the radar adopts the one-dimensional linear MIMO array for angle detection, an angle between the radar and the to-be-detected target D is θ_{radar}. With reference to the geometric relationship in FIG. 2A, it may be determined that there is the following formula (2-1):

sin∠θ_{radar}=cos∠DCQ*sin∠QCE (2-1)
3.1) According to a folding angle formula in solid geometry, it may be determined that different angles meet the following formula (2-2):

cos∠DCE=cos∠QCE*cos∠DCQ (2-2)

3.2) Combined with the formula (2-1) and the formula (2-2), the following formula (3) may be obtained by simplification:

$$tan ∠ QCE = \frac{sin ∠ {θ}_{radar}}{cos ∠ DCE} \qquad ( 3 )$$

3.2) With reference to the geometric relationship in FIG. 2A, the foregoing formula (3) may be further simplified as the following formula (4):

QE=DG=R sin ∠θ_{radar} (4)
3.3) With reference to the geometric relationship in FIG. 2A, an included angle between OB and OD meets the following formula (5):

$$sin γ = \frac{DG}{\sqrt{{R}^{2} - {H}^{2}}} \qquad ( 5 )$$

3.4) With reference to the geometric relationship in FIG. 2A, CE may be calculated by using the following formula (6):

CE=H sin α+OG cos α (6)
3.5) By using a principle of similar triangles, it may be determined that a ratio among line segments meets the following formula (7):

$$GE = \frac{BE * OC}{OB} \qquad ( 7 )$$

BE may be obtained by subtracting CE from Rs.

Therefore, based on the radar detection data and pose information detected by the detection radar, the three-dimensional coordinates of the any point D in the three-dimensional space in the detection radar coordinate system may be shown in the following formula (8):

$$[ R sin ∠ {θ}_{radar} , - \frac{BE * OC}{OB} , H sin α + OG cos α ] \qquad ( 8 )$$

As shown in the formula (8), when the data entry model determines three-dimensional coordinates of a target in the detection radar coordinate system based on radar detection data of the target, two parameters, namely, the ground height H and the pitch angle α, of the detection radar are introduced, so that a situation of the detection radar when the ground height and the pitch angle change can be better reflected.

Second, a coordinate conversion relationship between the detection radar coordinate system and the image acquisition device coordinate system may be represented through a constructed orthogonal rotation matrix and a three-dimensional translation vector. The coordinate conversion relationship between the detection radar coordinate system and the image acquisition device coordinate system may be represented by the following formula (9):

$$( \begin{matrix}\begin{matrix}\begin{matrix}{X}_{c} \\ {Y}_{c}\end{matrix} \\ {Z}_{c}\end{matrix} \\ 1\end{matrix} ) = ( \begin{matrix}R & t \\ {0}^{T} & 1\end{matrix} ) ( \begin{matrix}\begin{matrix}\begin{matrix}{X}_{r} \\ {Y}_{r}\end{matrix} \\ {Z}_{r}\end{matrix} \\ 1\end{matrix} ) \qquad ( 9 )$$

(Xᵣ, Yᵣ, Zᵣ) represents coordinate positions in the detection radar coordinate system, (X_{c}, Y_{c}, Z_{c}) represents coordinate positions in the image acquisition device coordinate system, R is the orthogonal rotation matrix and t is the three-dimensional translation vector. The three-dimensional translation vector and the orthogonal rotation matrix may be shown in the following formulas (9-1) and (9-2) respectively:

$$t = ( \begin{matrix}\begin{matrix}{X}_{t} & {Y}_{t}\end{matrix} & {{Z}_{t} )}^{T}\end{matrix} \qquad ( 9 - 1 )$$

$$R = ( \begin{matrix}1 & 0 & 0 \\ 0 & cos θ & - sin θ \\ 0 & sin θ & cos θ\end{matrix} ) ( \begin{matrix}cos β & 0 & - sin β \\ 0 & 1 & 0 \\ sin β & 0 & cos β\end{matrix} ) ( \begin{matrix}cos ϑ & - sin ϑ & 0 \\ sin ϑ & cos ϑ & 0 \\ 0 & 0 & 1\end{matrix} ) \qquad ( 9 - 2 )$$

When it is known that a plurality of three-dimensional space sample points are in the detection radar coordinate system and the image acquisition device coordinate system, three-dimensional rotation angles in the orthogonal rotation matrix and translations in the three-dimensional translation vector may be calculated and determined in any suitable manner, so that the coordinate conversion relationship between the detection radar coordinate system and the image acquisition device coordinate system is obtained.

It should be noted that specific methods for calculating and determining the orthogonal rotation matrix and the three-dimensional translation vector are well known to a person skilled in the art. Details are not described herein.

Then, FIG. 2B is a schematic diagram of a projection relationship between an image acquisition device coordinate system and a two-dimensional image coordinate system according to an embodiment of the present disclosure, which shows a situation in which the image acquisition device coordinate system is converted from a three-dimensional projection to a two-dimensional coordinate system.

As shown in FIG. 2B, a coordinate origin of the image acquisition device coordinate system is O_{c} and three coordinate axes thereof are represented as X_{c}, Y_{c}, and Z_{c} respectively. A coordinate origin of the two-dimensional image coordinate system is O and two coordinate axes thereof are represented as x and y respectively. P is any point in the image acquisition device coordinate system and p is a projection of P onto an imaging plane.
1.1) In FIG. 2B, a triangle enclosed by points O_{c}, C, and p and a triangle enclosed by points O_{c}, B, and P are similar triangles. A triangle enclosed by points O_{c}, C, and O and a triangle enclosed by points O_{c}, B and A are also similar triangles. Therefore, the following formula (10) may be obtained:

$$\frac{CO}{AB} = \frac{{OO}_{c}}{{AO}_{c}} = \frac{pC}{PB} = \frac{x}{{X}_{c}} = \frac{f}{{Z}_{c}} = \frac{y}{{Y}_{c}} \qquad ( 10 )$$

f is a focal length, coordinates of P in the image acquisition device coordinate system are represented as (Xc, Yc, Zc) and coordinates of p in the two-dimensional image coordinate system are represented as (x,y).
1.2) After the formula (10) is converted, coordinate data of p as shown in the following formula (11) may be obtained:

$$\{ \begin{matrix}x = f \frac{{X}_{c}}{{Z}_{c}} \\ y = f \frac{{Y}_{c}}{{Z}_{c}}\end{matrix} \qquad ( 11 )$$

1.3) By sorting out the formula (10), a coordinate conversion relationship between the image acquisition device coordinate system and the two-dimensional image coordinate system may be obtained as shown in the following formula (12):

$${Z}_{c} ( \begin{matrix}\begin{matrix}x \\ y\end{matrix} \\ 1\end{matrix} ) = ( \begin{matrix}f & 0 & 0 \\ 0 & f & 0 \\ 0 & 0 & 1\end{matrix} ) ( \begin{matrix}\begin{matrix}{X}_{c} \\ {Y}_{c}\end{matrix} \\ {Z}_{c}\end{matrix} ) \qquad ( 12 )$$

Finally, coordinate data in the two-dimensional image coordinate system obtained through conversion of the formula (12) usually adopts a similar length unit such as mm, rather than discrete pixel points. However, when a commonly used image acquisition device (such as a digital camera) acquires an image, a standard electrical signal is first formed and is then converted to a digital image through digital-to-analog conversion. A storage form of each acquired image is an M×N array. A value of each element in the image of M rows and N columns represents a grayscale of the image. Therefore, a coordinate conversion relationship between the two-dimensional image coordinate system and the two-dimensional pixel coordinate system may be further determined, to complete data fusion of the radar detection data and the visual image data.

FIG. 2C is a schematic diagram of a correspondence between a two-dimensional image coordinate system and a two-dimensional pixel coordinate system according to an embodiment of the present disclosure. As shown in FIG. 2C, the two-dimensional image coordinate system takes a center of an image plane as a coordinate origin and two coordinate axes thereof are respectively parallel to two perpendicular edges of the image plane and are represented by using X and Y respectively. Coordinates in the two-dimensional image coordinate system may be represented by using (x,y) and is measured by mm.

The two-dimensional pixel coordinate system takes a vertex in an upper left corner of an image plane as an origin and two coordinate axes thereof are respectively parallel to the X axis and the Y axis of the two-dimensional image coordinate system and are represented by using U and V respectively. Coordinates in the two-dimensional pixel coordinate system may be represented by using (u,v).

By setting that one pixel is equal to d mm, the coordinate conversion relationship between the two-dimensional image coordinate system and the two-dimensional pixel coordinate system may be shown in the following formula (13):

$$\{ \begin{matrix}u = \frac{x}{dx} + {u}_{0} \\ v = \frac{y}{dy} + {v}_{0}\end{matrix} \qquad ( 11 )$$

(uₒ, vₒ) is coordinates of the coordinate origin of the two-dimensional image coordinate system in the two-dimensional pixel coordinate system. Further, the formula (13) may be sorted out, to obtain the coordinate conversion relationship shown in a formula (14):

$$( \begin{matrix}u \\ v \\ 1\end{matrix} ) = ( \begin{matrix}\frac{1}{dx} & 0 & {u}_{0} \\ 0 & \frac{1}{dy} & {v}_{0} \\ 0 & 0 & 1\end{matrix} ) ( \begin{matrix}x \\ y \\ 1\end{matrix} ) \qquad ( 14 )$$

Therefore, based on the specific instance of the foregoing data entry model, any point located in the three-dimensional space may be converted from the detection radar coordinate system to the pixel coordinate system by using the following formula (15), to implement data fusion of the visual image data and the radar detection data. The formula (15) is obtained by combining the foregoing formula (9), formula (12) and formula (14).

$$\begin{matrix}{Z}_{c} ( \begin{matrix}u \\ v \\ 1\end{matrix} ) = ( \begin{matrix}\frac{1}{dx} & 0 & {u}_{0} \\ 0 & \frac{1}{dy} & {v}_{0} \\ 0 & 0 & 1\end{matrix} ) ( \begin{matrix}f & 0 & 0 \\ 0 & f & 0 \\ 0 & 0 & 1\end{matrix} ) ( \begin{matrix}{X}_{c} \\ {Y}_{c} \\ {Z}_{c}\end{matrix} ) = ( \begin{matrix}f \frac{1}{dx} & 0 & {u}_{0} \\ 0 & f \frac{1}{dy} & {v}_{0} \\ 0 & 0 & 1\end{matrix} ) ( \begin{matrix}{X}_{c} \\ {Y}_{c} \\ {Z}_{c}\end{matrix} ) \\ = ( \begin{matrix}f \frac{1}{dx} & 0 & {u}_{0} \\ 0 & f \frac{1}{dy} & {v}_{0} \\ 0 & 0 & 1\end{matrix} ) ( \begin{matrix}R & t\end{matrix} ) ( \begin{matrix}{X}_{r} \\ {Y}_{r} \\ {Z}_{r}\end{matrix} ) = K * T * ( \begin{matrix}{X}_{r} \\ {Y}_{r} \\ {Z}_{r}\end{matrix} )\end{matrix} \qquad ( 15 )$$

A person skilled in the art may understand that, in the foregoing formula (15), K is an intrinsic parameter of the image acquisition device. A specific method for obtaining K is well known to a person skilled in the art and K may be determined by a calibration method such as a Zhang Zhengyou calibration method. Details are not described herein. T is a calibration parameter related to the height and the pitch angle of the detection radar and changes with the height and the pitch angle of the detection radar.

It should be noted that the specific instance of the data entry model provided in the embodiments of the present disclosure is only used to describe how to introduce height information and pitch angle information of the detection radar into the coordinate conversion relationship between the detection radar coordinate system and the two-dimensional pixel coordinate system, which are not intended to limit the scope of the present disclosure. According to an actual situation such as a practical need or a characteristic of a specific use scenario, a person skilled in the art easily thinks of adjusting, replacing or changing one or more of steps and parameters, to obtain another data entry model through reasonable derivation.

One of advantages of the data entry model provided in the embodiments of the present disclosure is: Impact of an attitude change of a detection radar in three-dimensional space is considered and a problem that a data entry model fails because a height and a pitch angle change is effectively resolved.

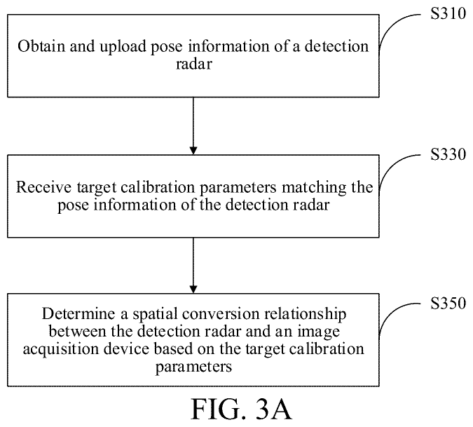

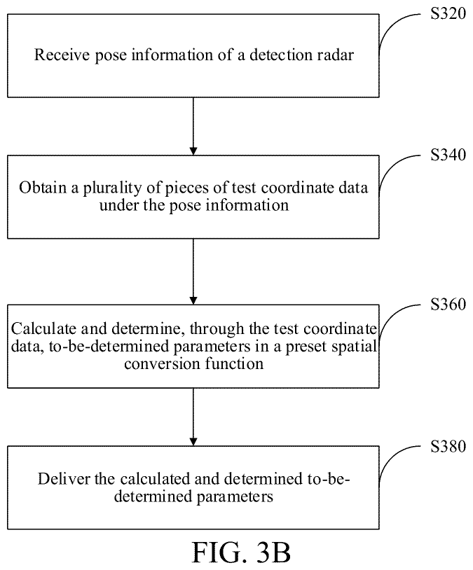

Based on the data entry model related to the height and the pitch angle of the detection radar, the embodiments of the present disclosure further provide a joint calibration method. The joint calibration method is set based on a data entry model that introduces an attitude change of a detection radar. FIG. 3A is a method flowchart of a joint calibration method according to an embodiment of the present disclosure. The joint calibration method may be performed by the flight controller 14, to help to implement data fusion of the radar detection data of the unmanned aerial vehicle and the visual image data. As shown in FIG. 3A, the joint calibration method includes the following steps.

S310: Obtain and upload pose information of a detection radar.

The pose information may include a ground height of the detection radar and a pitch angle of the detection radar. In actual operation, by using the application scenario shown in FIG. 1 as an example, the ground height of the detection radar fixed on a gimbal of an unmanned aerial vehicle is a flight height of the unmanned aerial vehicle, which may be obtained by detection of a sensor device of the unmanned aerial vehicle, for example, a height finder radar, a GPS module or an altitude sensor. The pitch angle of the detection radar may be determined by reading an inclination angle of the gimbal of the unmanned aerial vehicle. In a preferable embodiment, the ground height of the detection radar may be obtained by adopting a height finder radar with high detection accuracy to detect. In some embodiments, the detection radar may be a millimeter-wave radar that can obtain depth information of an object.

In this embodiment, a term such as “upload” is used to indicate an operating process in which the pose information obtained by the unmanned aerial vehicle 10 is transferred to the server 20, which may be implemented by adopting a data transfer manner corresponding to a data form of any suitable type. This is not limited herein.

S330: Receive target calibration parameters matching the pose information of the detection radar.

The “target calibration parameters” are a group of calibration parameters matching current pose information of the detection radar. In actual operation, the target calibration parameters may be calculated by the server 20 based on the preset model and the current pose information. Such target calibration parameters after being determined or generated may be wirelessly transmitted in any suitable manner and received by the controller 14 of the unmanned aerial vehicle.

S350: Determine a spatial conversion relationship between the detection radar and an image acquisition device based on the target calibration parameters.

The “spatial conversion relationship” is a correspondence from the detection radar to the image acquisition device. The spatial conversion relationship may be represented by one or more rotation matrices or other similar manners, so that the radar detection data and/or visual image data can be converted among a plurality of different coordinate systems, to complete data fusion between the detection radar and the image acquisition device.

In some embodiments, by using the specific instance of the foregoing data entry model as an example, the target calibration parameters may be T in the formula (15). After the target calibration parameters T are determined, the spatial conversion relationship between the detection radar and the image acquisition device may be correspondingly obtained.

In some embodiments, the foregoing spatial conversion relationship may include: a coordinate correspondence between radar detection data of a target and three-dimensional coordinates of the target in a detection radar coordinate system, a first coordinate conversion relationship between the detection radar coordinate system and an image acquisition device coordinate system, a second coordinate conversion relationship between the image acquisition device coordinate system and a two-dimensional image coordinate system and a third coordinate conversion relationship between the two-dimensional image coordinate system and a two-dimensional pixel coordinate system.

As shown in FIG. 2A and the formula (8), the coordinate correspondence is a function related to the ground height and the pitch angle of the detection radar. Under a specific ground height and pitch angle, a distance R of the target and a target horizontal angle θ_{radar} that are obtained based on detection of the millimeter-wave radar may be correspondingly converted to obtain the three-dimensional coordinates of the target in the detection radar coordinate system.

In other words, changes of the ground height and the pitch angle of the detection radar cause the three-dimensional coordinates of the same target in the detection radar coordinate system to change. Through such a manner, attitude change information of the detection radar is also introduced into the model, which can more accurate data fusion between the radar detection data obtained by the detection radar and the visual image data obtained by the image acquisition device.

In addition, the first coordinate conversion relationship may be represented by the formula (9), the second coordinate conversion relationship may be represented by the formula (12) and the third coordinate conversion relationship may be represented by the formula (14). By integrating the first coordinate conversion relationship, the second coordinate conversion relationship and the third coordinate conversion relationship, a spatial conversion function between the detection radar coordinate system and the two-dimensional pixel coordinate system may be obtained as shown in the formula (15).

One of advantages of the joint calibration method provided in this embodiment of the present disclosure is: Calibration parameters may be correspondingly corrected according to a change of pose information of a detection radar, to obtain an accurate spatial conversion relationship matching a current position of the detection radar. Based on the spatial conversion relationship, radar detection data obtained by the detection radar can be easily converted in a two-dimensional pixel coordinate system, to implement data fusion between depth information and multi-source data such as image visual image data.

FIG. 3B shows a joint calibration method according to another embodiment of the present disclosure, which may be performed by the server 20 and cooperate with the method steps shown in FIG. 3A to help the unmanned aerial vehicle 10 to complete joint calibration between the detection radar and the controller of the unmanned aerial vehicle. As shown in FIG. 3B, the joint calibration method includes the following steps.

S320: Receive pose information of a detection radar.

The pose information may include a ground height of the detection radar and a pitch angle of the detection radar. Step S320 is a step opposite to step S310. In actual operation, the pose information may come directly or indirectly from the unmanned aerial vehicle 10.

S340: Obtain a plurality of pieces of test coordinate data under the pose information.

The test coordinate data is known. Coordinate data of some test points in different coordinate systems may be obtained in any suitable manner, for example, obtained from a software simulation environment.

S360: Calculate and determine, through the test coordinate data, to-be-determined parameters in a preset spatial conversion function.

The preset spatial conversion function is configured to represent the spatial conversion relationship between the detection radar and the image acquisition device. The preset spatial conversion function and the spatial conversion relationship may have a same expression or similar expressions. In this embodiment, because there is a plurality of to-be-determined parameters, the “spatial conversion function” is referred to be distinguished from the “spatial conversion relationship” in step S350.

In some embodiments, test coordinate data is related to an actually used spatial conversion function (or spatial conversion relationship). In some embodiments, when the spatial conversion relationship between the detection radar and the image acquisition device includes the coordinate conversion relationship between the detection radar coordinate system and the two-dimensional pixel coordinate system, the test coordinate data may include first coordinate data of a test point in the detection radar coordinate system and second coordinate data of the same test point in the two-dimensional pixel coordinate system.

S380: Deliver the calculated and determined to-be-determined parameters.

The calculated and determined to-be-determined parameters are the target calibration parameters in step S340, which may be provided to the unmanned aerial vehicle in any suitable data transfer manner.

In this embodiment, a term such as “upload” is used to indicate an operating process in which the to-be-determined parameters calculated and determined by the server 20 are transferred to the unmanned aerial vehicle 10, which may be implemented by adopting a data transfer manner corresponding to a data form of any suitable type. This is not limited herein.

One of advantages of the joint calibration method provided in this embodiment of the present disclosure is: By using a significantly greater computing capability of a server, an unmanned aerial vehicle can rapidly complete calculation of target calibration parameters that change with pose information of a detection radar, so that the unmanned aerial vehicle can be used in a high real-time scenario.

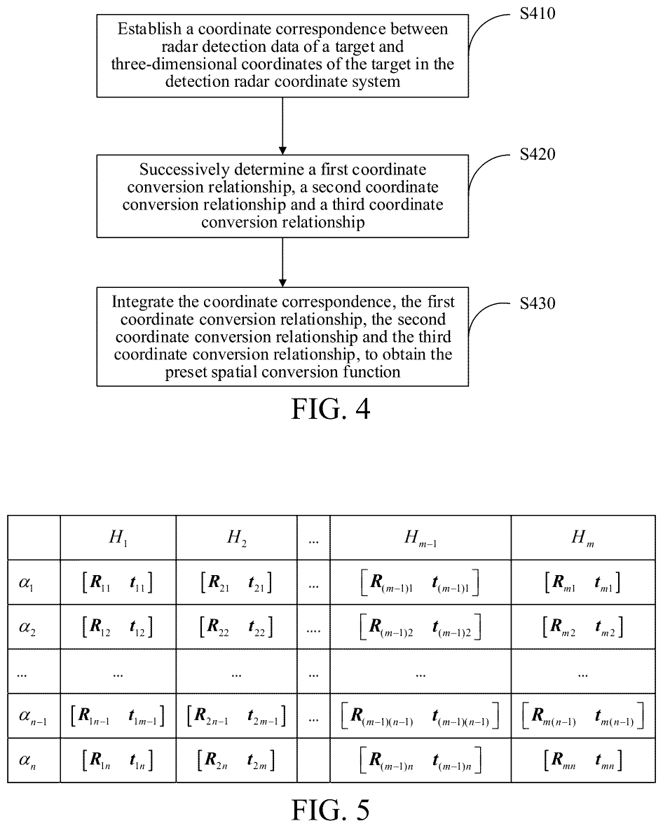

In some embodiments, by using the specific instance of the foregoing data entry model as an example, as shown in FIG. 4, specific steps of obtaining the spatial conversion function may include the following steps.

S410: Establish a coordinate correspondence between radar detection data of a target and three-dimensional coordinates of the target in the detection radar coordinate system.

The coordinate correspondence may be shown in the formula (8) and is a three-dimensional coordinate expression related to the ground height and the pitch angle. The coordinate correspondence may represent the three-dimensional coordinates of the target by using a distance between the detection radar and the target and a target horizontal angle between the detection radar and the target.

S420: Successively determine a first coordinate conversion relationship between the detection radar coordinate system and an image acquisition device coordinate system, a second coordinate conversion relationship between the image acquisition device coordinate system and a two-dimensional image coordinate system, and a third coordinate conversion relationship between the two-dimensional image coordinate system and the two-dimensional pixel coordinate system.

The first coordinate conversion relationship, the second coordinate conversion relationship, and the third coordinate conversion relationship are shown in the formula (9), the formula (12), and the formula (14) respectively. Herein, “first”, “second” and “third” are only used to distinguish coordinate conversion relationships among different coordinate systems and are not used to limit specific aspects such as expression manners thereof.

S430: Integrate the coordinate correspondence, the first coordinate conversion relationship, the second coordinate conversion relationship and the third coordinate conversion relationship, to obtain the preset spatial conversion function.

In this embodiment, the term “integration” is used to indicate one or more data operation operations that combine a plurality of conversion relationships with a plurality of three-dimensional coordinate expressions and perform corresponding simplification and/or sorting. Specific mathematical operations are not limited herein and may be adjusted or set according to needs of an actual situation, as long as a correspondence between the target in the detection radar coordinate system and the target in the two-dimensional pixel coordinate system can be determined.

To fully described the method for determining the to-be-determined parameters by the server in this embodiment of the present disclosure, the following uses the data entry model shown in the formula (15) as an example to describe in detail a specific process of determining the spatial conversion function and the to-be-determined parameters in the function.

1) Divide continuous height intervals.

First, a division step value of the height intervals and a ground height range are set.

The division step value is an empirical value, which may be set or adjusted by technical personnel according to needs of an actual situation. Preferably, the used division step value may be appropriately expanded to reduce a quantity of divided height intervals and reduce adjustment parameters of an extrinsic parameter. The ground height range may be set according to an actual situation such as a flight height range of the unmanned aerial vehicle when normally working, which is not specifically limited herein.

Then, the ground height range is divided into m height intervals according to the following formula (16-1):

$${H}_{m} = ceil ( \frac{{H}_{max} - {H}_{min}}{Δ H} ) \qquad ( 16 - 1 )$$

A subscript m is a sequence number of a height interval, ceil is rounding up, Hₘₐₓ is an upper limit value of the ground height range, Hₘᵢₙ is a lower limit value of the ground height range and ΔH is the division step value.

2) Divide continuous pitch angle intervals.

First, a division step value of the pitch angle intervals and a pitch angle range are set.

The division step value of the pitch angle intervals is similar to the division step value of the height intervals and is also an empirical value, which may be set or adjusted by technical personnel according to needs of an actual situation. The pitch angle range is set according to a pitch angle interval within which the gimbal may adjust when the unmanned aerial vehicle normally works, which is not specifically limited herein. Preferably, a larger pitch angle range may be selected and set to cover extreme situations in a flight process of the unmanned aerial vehicle as much as possible, to ensure correctness of the calibration parameters.

Then, the pitch angle range is divided into n pitch angle intervals according to the following formula (16-2):

$${α}_{n} = ceil ( \frac{{α}_{max} - {α}_{min}}{Δ α} ) \qquad ( 16 - 2 )$$

A subscript n is a sequence number of the pitch angle interval, ceil is rounding up, αₘₐₓ is an upper limit value of the pitch angle range, αₘᵢₙ is a lower limit value of the pitch angle range and Δα is the division step value.

Therefore, by combining the m height intervals and the n pitch angle intervals that are obtained through the foregoing division, m*n pose information intervals may be formed.

3) Calculation of the calibration parameters.

Assuming that for a test target in space, it is known that coordinates of the test target in the two-dimensional pixel coordinate system are p and coordinates of the test target in the detection radar coordinate system are q, the foregoing formula (15) may be sorted out and transformed into the following formula (17):

p=K[R t]_{q} (17)

K is an intrinsic parameter that does not change with the height and the pitch angle of the detection radar and may be obtained by calibrating the image acquisition device in a manner such as a Zhang Zhengyou calibration method. R and t are calibration parameters that need to be determined.

As described in the foregoing data entry model, there are totally six items of calibration parameters that need to be solved and determined in R and t, which are shown in the following formula (18):

w=[θₓ,θ_{y},θ_{z},tₓ,t_{y},t_{z}] (18)

θₓ, θ_{y} and θ_{z} are respectively rotation angles of coordinate axes and tₓ, t_{y} and t_{z} are respectively movement amounts of the coordinate axes in corresponding directions.

Based on a plurality of groups of known coordinates p and q that correspond to each other, the foregoing six items of calibration parameters are determined by solving a nonlinear optimal solution of a constraint function shown in the following formula (19), to be used as a group of calibration parameters matching a pose information interval.

$${arg min}_{w} {\sum }_{i = 1}^{N} {‖ {\tilde{q}}_{i} - K [ \begin{matrix}R & t\end{matrix} ] {\tilde{p}}_{i} ‖}_{2}^{2} \qquad ( 19 )$$

4) Generate the calibration parameter set.

By changing the height and the pitch angle of the detection radar for a plurality of times and repeating step 3), all m*n pose information intervals and a group of calibration parameters matching each pose information interval can be obtained through traversal. A plurality of groups of calculated calibration parameters and corresponding matching relationships between the plurality of groups of calibration parameters and the pose information intervals may be recorded by a calibration parameter table shown in FIG. 5.

As shown in FIG. 5, Hₘ represents a height interval within which a current ground height of the detection radar is, αₙ represents a pitch angle interval within which a current pitch angle of the detection radar is and [Rₘₙ tₘₙ] represents a group of calibration parameters matching the height interval Hₘ and the pitch angle interval an.

The foregoing step 1) to step 4) for generating the calibration parameter set may be performed in a simulated environment pre-built in an electronic computing platform, to obtain the calibration parameter table shown in FIG. 5. The calibration parameter table is stored in a non-volatile storage medium for easy invoking.

In some embodiments, the height interval and the pitch angle interval in the foregoing step 1) and step 2) may be continuously reduced until the height interval and the pitch angle interval are reduced to a numerical point. Therefore, the server may skip step 1) and step 2) and directly perform step 3) according to current ground height and pitch angle of the detection radar, to obtain calibration parameters matching current pose information.

A person skilled in the art may understand that narrower numerical ranges of the height interval and the pitch angle interval indicate more accurate calculated calibration parameters matching the current pose information. However, correspondingly, narrower numerical ranges of the height interval and the pitch angle interval indicate greater calculation amounts required for the calculated calibration parameters. In an application scenario of a server with a significantly greater computing capability, it is preferable to select a narrower interval range or even a numerical point to obtain more accurate calibration parameters.

In some other embodiments, the calibration parameters calculated in the foregoing step 3) may alternatively be stored entirely or partially in a storage medium according to needs of an actual situation for easy invoking. A person skilled in the art may understand that pre-calculating more calibration parameters and storing the calibration parameters in a storage medium is conducive to improving efficiency of calculating and determining the calibration parameters by the server and can also reduce required calculation amounts. Adopting a real-time computing manner can reduce a demand for storage space. In an application scenario with enough storage space, it is preferable to select to pre-calculate and save a calibration parameter corresponding to each numerical point, to provide preferable real-time performance to meet needs of the unmanned aerial vehicle in actual use.

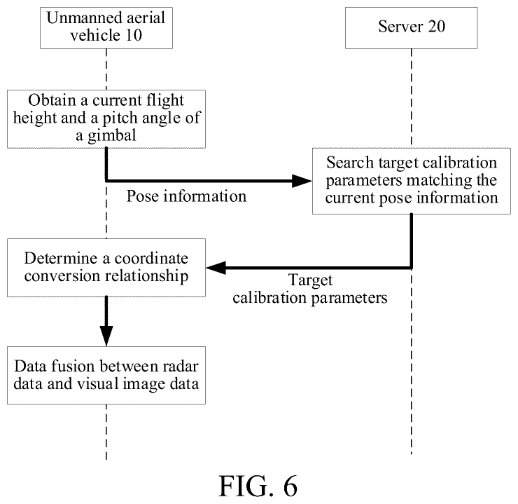

When data fusion between the radar detection data and the visual image data is performed in an application scenario shown in FIG. 1, as shown in FIG. 6, an unmanned aerial vehicle 10 first obtains, based on a related sensor device, a current flight height of the unmanned aerial vehicle and a current pitch angle of a gimbal as pose information to package to send to a server 20. The server 20 searches, based on the received pose information, target calibration parameters matching current pose information in pre-stored calibration parameters. Then, the server 20 packages the target calibration parameters to send to the unmanned aerial vehicle 10. Finally, the unmanned aerial vehicle 10 determines a coordinate conversion relationship between a detection radar coordinate system and a two-dimensional pixel coordinate system by using the read calibration parameters, so that the radar detection data can be accurately converted in the two-dimensional pixel coordinate system, to implement data fusion between the radar detection data detected by the detection radar and the visual image data obtained by the image acquisition device.

For example, depth information of a target object obtained by a detection radar may be converted in the two-dimensional pixel coordinate system, to determine depth information of the target object in a pixel point, to implement functions such as threat terrain warning, threat obstacle highlighting and assisted flight, thereby helping an operator of the unmanned aerial vehicle to obtain an all-day, all-weather and all-terrain all-scenario environmental sensing capability and providing enough time for timely avoidance of dangerous terrain and obstacles.

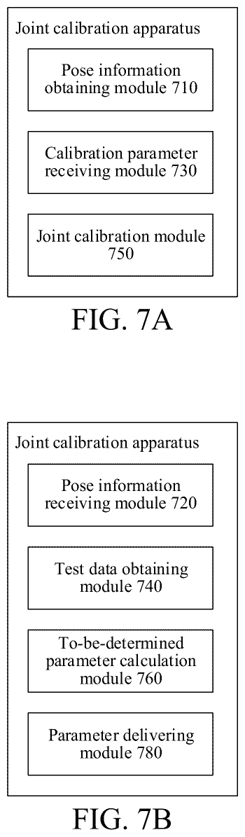

FIG. 7A is a functional block diagram of a joint calibration apparatus according to an embodiment of the present disclosure. As shown in FIG. 7A, the joint calibration apparatus may include a pose information obtaining module 710, a calibration parameter receiving module 730, and a joint calibration module 750.

The pose information obtaining module 710 is configured to obtain and upload pose information of a detection radar, the pose information including a ground height of the detection radar and a pitch angle of the detection radar. The calibration parameter receiving module 730 is configured to receive target calibration parameters matching the pose information of the detection radar. The joint calibration module 750 is configured to determine a spatial conversion relationship between the detection radar and an image acquisition device based on the target calibration parameters.

In some embodiments, the spatial conversion relationship between the detection radar and an image acquisition device includes: a coordinate correspondence between radar detection data of a target and three-dimensional coordinates of the target in a detection radar coordinate system, a first coordinate conversion relationship between the detection radar coordinate system and an image acquisition device coordinate system, a second coordinate conversion relationship between the image acquisition device coordinate system and a two-dimensional image coordinate system and a third coordinate conversion relationship between the two-dimensional image coordinate system and a two-dimensional pixel coordinate system.

In some embodiments, the coordinate correspondence is related to the pose information of the detection radar. The radar detection data includes a distance between the detection radar and the target and a target horizontal angle between the detection radar and the target.

FIG. 7B is a functional block diagram of a joint calibration apparatus according to another embodiment of the present disclosure. As shown in FIG. 7B, the joint calibration apparatus includes a pose information receiving module 720, a test data obtaining module 740, a to-be-determined parameter calculation module 760 and a parameter delivering module 780.

The pose information receiving module 720 is configured to receive pose information of a detection radar, the pose information including a ground height of the detection radar and a pitch angle of the detection radar. The test data obtaining module 740 is configured to obtain a plurality of pieces of test coordinate data under the pose information. The to-be-determined parameter calculation module 760 is configured to calculate and determine, through the test coordinate data, to-be-determined parameters in a preset spatial conversion function, where the preset spatial conversion function is configured to represent a spatial conversion relationship between the detection radar and an image acquisition device. The parameter delivering module 780 is configured to deliver the calculated and determined to-be-determined parameters.

It should be noted that in this embodiment of the present disclosure, functional modules with functional names are used as examples to describe in detail the method steps to be implemented by the joint calibration apparatus provided in this embodiment of the present disclosure. A person skilled in the art may clearly understand that, for simple and clear description, for specific work processes of the foregoing described apparatus and modules, reference may be made to a corresponding process in the foregoing method embodiments. Details are not described herein again. A person of ordinary skill in the art may be aware that, in combination with examples of units and algorithm steps described in the embodiments disclosed in this specification, this application may be implemented by using electronic hardware, computer software, or a combination thereof. To clearly describe the interchangeability between the hardware and the software, the compositions and steps of each example have been generally described according to functions in the foregoing descriptions. Whether such functions are performed by hardware or software depends on particular applications and design constraints of the technical solutions. A person skilled in the art may use different methods to implement the described functions for each particular application, but it should not be considered that the implementation goes beyond the scope of the present disclosure.

A person skilled in the art may use different methods to implement the described functions for each particular application, but this implementation shall not be considered as going beyond the scope of the present disclosure. The computer software may be stored in a computer-readable storage medium. When being executed, the program may include the processes of the embodiments of the foregoing methods. The storage medium may be a magnetic disk, an optical disc, a read-only memory (ROM), or a random access memory (RAM).

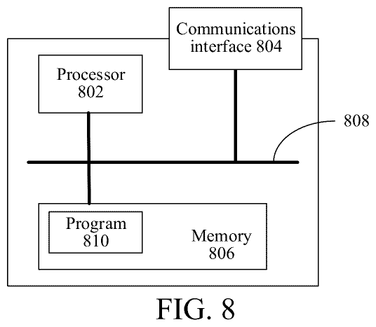

FIG. 8 is a schematic structural diagram of an electronic device according to an embodiment of the present disclosure. A specific implementation of the electronic device is not limited in this embodiment of the present disclosure. For example, the electronic device may be the flight controller 14 shown in FIG. 1. In some embodiments, the electronic device may alternatively be the server 20 shown in FIG. 1.

As shown in FIG. 8, the electronic device may include: a processor (processor) 802, a communications interface (Communications Interface) 804, a memory 806 and a communications bus 808.

The processor 802, the communications interface 804, and the memory 806 complete mutual communication by using the communications bus 808. The communications interface 804 is configured to implement network element communication with another device such as a client, another server, or the like. The processor 802 is configured to execute a program 810 and may perform related steps in the foregoing joint calibration method embodiments.

In some embodiments, the program 810 may include program code and the program code includes a computer operating instruction. In some embodiments, the computer operating instruction may cause the processor 802 to perform the joint calibration method in the foregoing any method embodiment.

In the embodiments of the present disclosure, according to a used hardware type, the processor 802 may be a central processing unit (CPU). The processor 802 may be further another general-purpose processor, a digital signal processor (DSP), an application specific integrated circuit (ASIC), a field-programmable gate array (FPGA), or another programmable logic device, a discrete gate or a transistor logic device, a discrete hardware component or the like.

The memory 806 is configured to store the program 810. The memory 806 may include a high-speed RAM memory, and may also include a non-volatile memory, for example, at least one magnetic disk memory, a flash component, or other non-volatile solid-state storage components.

The memory 806 has a program storage area and a data storage area, which are respectively used for storing the program 810 and corresponding data information, for example, a non-volatile software program and a non-volatile computer executable program and module stored in the program storage area, or an operation processing result, radar detection data, image information and the like stored in the data storage area.

An embodiment of the present disclosure further provides a computer-readable storage medium. The computer-readable storage medium may be a non-volatile computer-readable storage medium. The computer-readable storage medium stores a computer program.

The computer program, when executed by the processor, causes the processor to implement one or more steps in the joint calibration method disclosed in the embodiments of the present disclosure. A complete computer program product is embodied on one or more computer-readable storage mediums (including but not limited to, disk storage, CD-ROM, optical storage and the like) including the computer program disclosed in the embodiments of the present disclosure.

In conclusion, a data entry model constructed by the joint calibration method and apparatus provided in the embodiments of the present disclosure considers the impact of a working height and a pitch angle of a millimeter-wave radar on azimuth Direction Of Arrival (DOA) estimation. The data entry model may adaptively adjust calibration parameters to adapt to a working state under any height and pitch angle.

In addition, the foregoing data entry model and the joint calibration method are constructed based on three-dimensional space and have good expandability. On the basis of continuing to use a derivation method and calculation results of the embodiments of the present disclosure, the data entry model may degenerate to a typical two-dimensional data acquisition model by setting the height and the pitch angle to zero at the same time, to be used in a suitable scenario.

According to some embodiments of the joint calibration method, the spatial conversion relationship between the detection radar and an image acquisition device includes: a coordinate correspondence between radar detection data of a target and three-dimensional coordinates of the target in a detection radar coordinate system, a first coordinate conversion relationship between the detection radar coordinate system and an image acquisition device coordinate system, a second coordinate conversion relationship between the image acquisition device coordinate system and a two-dimensional image coordinate system and a third coordinate conversion relationship between the two-dimensional image coordinate system and a two-dimensional pixel coordinate system.

According to some embodiments of the joint calibration method, the coordinate correspondence is related to the pose information of the detection radar and the radar detection data includes a distance between the detection radar and the target and a target horizontal angle between the detection radar and the target.

According to some embodiments of the joint calibration method, the coordinate correspondence is shown in the following formula:

$$\{ \begin{matrix}{X}_{r} = R sin ∠ {θ}_{radar} \\ {Y}_{r} = - \frac{BE * OC}{OB} \\ {Z}_{r} = H * sin α + OG * cos α\end{matrix}$$

Coordinates of the target in the detection radar coordinate system are (Xᵣ, Yᵣ, Zᵣ), R is the distance between the target and the detection radar, O is a coordinate origin of a world coordinate system, B is an intersection between a z axis of the detection radar coordinate system and an x axis of the world coordinate system, C is a coordinate origin of the detection radar coordinate system, G is an intersection between a perpendicular line passing through the target and the x axis of the world coordinate system, E is an intersection between a perpendicular line passing through G and the z axis of the detection radar coordinate system, H is the ground height of the detection radar, α is the pitch angle of the detection radar and θ_{radar} is the target horizontal angle between the detection radar and the target.

According to some embodiments of the joint calibration method, the first coordinate conversion relationship is shown in the following formula:

$$( \begin{matrix}{X}_{c} \\ {Y}_{c} \\ {Z}_{c} \\ 1\end{matrix} ) = ( \begin{matrix}R & t \\ {0}^{T} & 1\end{matrix} ) ( \begin{matrix}{X}_{r} \\ {Y}_{r} \\ {Z}_{r} \\ 1\end{matrix} )$$

Coordinates of the target in the detection radar coordinate system are (Xᵣ, Yᵣ, Zᵣ), coordinates of the target in the image acquisition device coordinate system are (X_{c}, Y_{c}, Z_{c}), R is an orthogonal rotation matrix and t is a three-dimensional translation vector.

According to some embodiments of the joint calibration method, the second coordinate conversion relationship is shown in the following formula:

$${Z}_{c} ( \begin{matrix}x \\ y \\ 1\end{matrix} ) = ( \begin{matrix}f & 0 & 0 \\ 0 & f & 0 \\ 0 & 0 & 1\end{matrix} ) ( \begin{matrix}{X}_{c} \\ {Y}_{c} \\ {Z}_{c}\end{matrix} )$$

Coordinates of the target in the image acquisition device coordinate system are (X_{c}, Y_{c}, Z_{c}), coordinates of the target in the two-dimensional image coordinate system are (x,y) and f is a focal length.

According to some embodiments of the joint calibration method, the third coordinate conversion relationship is shown in the following formula:

$$( \begin{matrix}u \\ v \\ 1\end{matrix} ) = ( \begin{matrix}\frac{1}{dx} & 0 & {u}_{0} \\ 0 & \frac{1}{dy} & {v}_{0} \\ 0 & 0 & 1\end{matrix} ) ( \begin{matrix}x \\ y \\ 1\end{matrix} )$$

Coordinates of a coordinate origin of the two-dimensional image coordinate system in the two-dimensional pixel coordinate system are (uₒ, vₒ), coordinates of the target in the two-dimensional pixel coordinate system are (u,v), coordinates of the target in the two-dimensional image coordinate system are (x,y) and d is a ratio of a single pixel length in the two-dimensional pixel coordinate system to a unit length in the two-dimensional image coordinate system.

According to some embodiments of the joint calibration method, the spatial conversion relationship between the detection radar and the image acquisition device includes a coordinate conversion relationship between the detection radar coordinate system and the two-dimensional pixel coordinate system; and the test coordinate data includes first coordinate data of a test point in a detection radar coordinate system and second coordinate data of the same test point in a two-dimensional pixel coordinate system.

According to some embodiments of the joint calibration method, the method further includes: establishing a coordinate correspondence between radar detection data of a target and three-dimensional coordinates of the target in the detection radar coordinate system; successively determining a first coordinate conversion relationship between the detection radar coordinate system and an image acquisition device coordinate system, a second coordinate conversion relationship between the image acquisition device coordinate system and a two-dimensional image coordinate system and a third coordinate conversion relationship between the two-dimensional image coordinate system and the two-dimensional pixel coordinate system; and integrating the coordinate correspondence, the first coordinate conversion relationship, the second coordinate conversion relationship and the third coordinate conversion relationship, to obtain the preset spatial conversion function, where the coordinate correspondence is related to the pose information of the detection radar and the radar detection data includes a distance between the detection radar and the target and a target horizontal angle between the detection radar and the target.

According to some embodiments of the joint calibration method, the preset spatial conversion function is shown in the following formula:

p=K[R t]_{q}

Coordinates q are the first coordinate data, coordinates p are the second coordinate data, K is an intrinsic parameter of the image acquisition device, R is an orthogonal rotation matrix and t is a three-dimensional translation vector.

The orthogonal rotation matrix and the three-dimensional translation vector include a plurality of to-be-determined parameters shown in the following formula:

w=[θₓ,θ_{y},θ_{z},tₓ,t_{y},t_{z}],

θₓ, θ_{y} and θ_{z} are respectively rotation angles of coordinate axes and tₓ, t_{y} and t_{z} are respectively movement amounts of the coordinate axes in corresponding directions.

According to some embodiments of the joint calibration method, the calculating and determining, through the test coordinate data, to-be-determined parameters in a preset spatial conversion function further includes:
calculating and determining the to-be-determined parameters by calculating a nonlinear optimal solution of the following constraint function:

$${arg min}_{w} {\sum }_{i = 1}^{N} {‖ {\tilde{q}}_{i} - K [ \begin{matrix}R & t\end{matrix} ] {\tilde{p}}_{i} ‖}_{2}^{2}$$

p is coordinate data of the test point in the two-dimensional pixel coordinate system, q is coordinate data of the test point in the detection radar coordinate system, K is the intrinsic parameter of the image acquisition device, R is the orthogonal rotation matrix and t is the three-dimensional translation vector.

According to some embodiments, the unmanned aerial vehicle further includes a gimbal, the gimbal being disposed on the abdomen of the body, and the detection radar and the image acquisition device being disposed on the gimbal, where the flight controller is configured to obtain a pitch angle of the detection radar through an inclination angle of the gimbal.

According to some embodiments, the unmanned aerial vehicle further includes a height finder radar, the height finder radar being disposed on the body and being configured to detect a ground height of the unmanned aerial vehicle, where the flight controller is configured to obtain a ground height of the detection radar through the ground height of the unmanned aerial vehicle detected by the height finder radar.

Finally, it should be noted that the foregoing embodiments are merely used for describing the technical solutions of the present disclosure, but are not intended to limit the present disclosure. Under the ideas of the present disclosure, the technical features in the foregoing embodiments or different embodiments may also be combined, the steps may be performed in any order and many other changes of different aspects of the present disclosure also exists as described above. These changes are not provided in detail for simplicity. It should be understood by a person of ordinary skill in the art that although the present disclosure has been described in detail with reference to the foregoing embodiments, modifications can be made to the technical solutions described in the foregoing embodiments, or equivalent replacements can be made to some technical features in the technical solutions and these modifications or replacements will not cause the essence of corresponding technical solutions to depart from the scope of the technical solutions in the embodiments of the present disclosure.

What is claimed is:

1. A joint calibration method implemented by an unmanned aerial vehicle, comprising:
obtaining pose information of a detection radar of the unmanned aerial vehicle, and uploading the pose information of the detection radar to a server, the pose information comprising a ground height of the detection radar and a pitch angle of the detection radar;
receiving target calibration parameters matching the pose information of the detection radar from the server;
determining a spatial conversion relationship between the detection radar and an image acquisition device of the unmanned aerial vehicle based on the target calibration parameters; and
performing data fusion between radar data of the detection radar and visual image data of the image acquisition device according to the spatial conversion relationship.

2. The method according to claim 1, wherein the spatial conversion relationship between the detection radar and the image acquisition device comprises:
a coordinate correspondence between radar detection data of a target and three-dimensional coordinates of the target in a detection radar coordinate system;
a first coordinate conversion relationship between the detection radar coordinate system and an image acquisition device coordinate system;
a second coordinate conversion relationship between the image acquisition device coordinate system and a two-dimensional image coordinate system; and
a third coordinate conversion relationship between the two-dimensional image coordinate system and a two-dimensional pixel coordinate system.

3. The method according to claim 2, wherein the coordinate correspondence is related to the pose information of the detection radar; and
the radar detection data comprises a distance between the detection radar and the target, and a target horizontal angle between the detection radar and the target.

4. The method according to claim 3, wherein the coordinate correspondence is shown in the following formula:
$$\{ \begin{matrix}{X}_{r} = R sin ∠ {θ}_{radar} \\ {Y}_{r} = - \frac{BE * OC}{OB} \\ {Z}_{r} = H * sin α + OG * cos α\end{matrix}$$
coordinates of the target in the detection radar coordinate system being (Xᵣ, Yᵣ, Zᵣ), R being the distance between the target and the detection radar, O being a coordinate origin of a world coordinate system, B being an intersection between a z axis of the detection radar coordinate system and an x axis of the world coordinate system, C being a coordinate origin of the detection radar coordinate system, G being an intersection between a perpendicular line passing through the target and the x axis of the world coordinate system, E being an intersection between a perpendicular line passing through G and the z axis of the detection radar coordinate system, H being the ground height of the detection radar, α being the pitch angle of the detection radar, and θ_{radar} being the target horizontal angle between the detection radar and the target.

5. The method according to claim 3, wherein the first coordinate conversion relationship is shown in the following formula:
$$( \begin{matrix}{X}_{c} \\ {Y}_{c} \\ {Z}_{c} \\ 1\end{matrix} ) = ( \begin{matrix}R & t \\ {0}^{T} & 1\end{matrix} ) ( \begin{matrix}{X}_{r} \\ {Y}_{r} \\ {Z}_{r} \\ 1\end{matrix} )$$
coordinates of the target in the detection radar coordinate system being (Xᵣ, Yᵣ, Zᵣ), coordinates of the target in the image acquisition device coordinate system being (X_{c}, Y_{c}, Z_{c}), R being an orthogonal rotation matrix and t being a three-dimensional translation vector.

6. The method according to claim 3, wherein the second coordinate conversion relationship is shown in the following formula:
$${Z}_{c} ( \begin{matrix}x \\ y \\ 1\end{matrix} ) = ( \begin{matrix}f & 0 & 0 \\ 0 & f & 0 \\ 0 & 0 & 1\end{matrix} ) ( \begin{matrix}{X}_{c} \\ {Y}_{c} \\ {Z}_{c}\end{matrix} )$$
coordinates of the target in the image acquisition device coordinate system being (X_{c}, Y_{c}, Z_{c}), coordinates of the target in the two-dimensional image coordinate system being (x,y), and f being a focal length.

7. The method according to claim 3, wherein the third coordinate conversion relationship is shown in the following formula:
$$( \begin{matrix}u \\ v \\ 1\end{matrix} ) = ( \begin{matrix}\frac{1}{dx} & 0 & {u}_{0} \\ 0 & \frac{1}{dy} & {v}_{0} \\ 0 & 0 & 1\end{matrix} ) ( \begin{matrix}x \\ y \\ 1\end{matrix} )$$
coordinates of a coordinate origin of the two-dimensional image coordinate system in the two-dimensional pixel coordinate system being (uₒ, vₒ), coordinates of the target in the two-dimensional pixel coordinate system being (u,v), coordinates of the target in the two-dimensional image coordinate system being (x,y), and d being a ratio of a single pixel length in the two-dimensional pixel coordinate system to a unit length in the two-dimensional image coordinate system.

8. A joint calibration method implemented by a server, comprising:
receiving pose information of a detection radar of an unmanned aerial vehicle, the pose information comprising a ground height of the detection radar and a pitch angle of the detection radar;
obtaining a plurality of pieces of test coordinate data under the pose information;
calculating and determining, through the test coordinate data, to-be-determined parameters in a preset spatial conversion function, wherein the preset spatial conversion function represents the spatial conversion relationship between the detection radar and an image acquisition device of the unmanned aerial vehicle; and
delivering the calculated and determined parameters to the unmanned aerial vehicle.

9. The method according to claim 8, wherein the spatial conversion relationship between the detection radar and the image acquisition device comprises a coordinate conversion relationship between a detection radar coordinate system and a two-dimensional pixel coordinate system; and
the test coordinate data comprises first coordinate data of a first test point in the detection radar coordinate system and second coordinate data of a second test point in the two-dimensional pixel coordinate system;
wherein the first test point and the second test point have same coordinate values.

10. The method according to claim 9, wherein the method further comprises:
establishing a coordinate correspondence between radar detection data of a target and three-dimensional coordinates of the target in the detection radar coordinate system;
determining a first coordinate conversion relationship between the detection radar coordinate system and an image acquisition device coordinate system, a second coordinate conversion relationship between the image acquisition device coordinate system and a two-dimensional image coordinate system, and a third coordinate conversion relationship between the two-dimensional image coordinate system and the two-dimensional pixel coordinate system; and
integrating the coordinate correspondence, the first coordinate conversion relationship, the second coordinate conversion relationship, and the third coordinate conversion relationship, to obtain the preset spatial conversion function;
wherein the coordinate correspondence is related to the pose information of the detection radar and the radar detection data comprises a distance between the detection radar and the target and a target horizontal angle between the detection radar and the target.

11. The method according to claim 9, wherein the preset spatial conversion function is shown in the following formula:
p=K[R t]_{q}
coordinates q being the first coordinate data, coordinates p being the second coordinate data, K being an intrinsic parameter of the image acquisition device, R being an orthogonal rotation matrix, and t being a three-dimensional translation vector; and
the orthogonal rotation matrix and the three-dimensional translation vector comprise the to-be-determined parameters shown in the following formula:
w=[θₓ,θ_{y},θ_{z},tₓ,t_{y},t_{z}],
θₓ, θ_{y} and θ_{z} respectively being rotation angles of coordinate axes, and tₓ, t_{y} and t_{z} respectively being movement amounts of the coordinate axes in corresponding directions, w being the calculated and determined parameters.

12. The method according to claim 11, wherein the calculating and determining, through the test coordinate data, to-be-determined parameters in a preset spatial conversion function further comprises:
calculating and determining the to-be-determined parameters by calculating a nonlinear optimal solution of the following constraint function:
$${arg min}_{w} {\sum }_{i = 1}^{N} {‖ {\tilde{q}}_{i} - K [ \begin{matrix}R & t\end{matrix} ] {\tilde{p}}_{i} ‖}_{2}^{2}$$
p being the second coordinate data of the second test point in the two-dimensional pixel coordinate system, q being the first coordinate data of the first test point in the detection radar coordinate system, K being the intrinsic parameter of the image acquisition device, R being the orthogonal rotation matrix, and t being the three-dimensional translation vector.

13. An unmanned aerial vehicle, comprising:
a body, a detection radar and an image acquisition device being disposed on the body;
arms, connected to the body;
power apparatuses, disposed on the arms and configured to provide power for the unmanned aerial vehicle to fly; and
a flight controller, disposed on the body and communicatively connected to the detection radar and the image acquisition device respectively, wherein
the flight controller stores a preset calibration parameter set and is configured to perform a joint calibration method, wherein the joint calibration method comprises:
obtaining pose information of the detection radar, and uploading the pose information of the detection radar to a server, the pose information comprising a ground height of the detection radar and a pitch angle of the detection radar;
receiving target calibration parameters matching the pose information of the detection radar from the server;
determining a spatial conversion relationship between the detection radar and the image acquisition device based on the target calibration parameters; and
performing data fusion between radar data of the detection radar and visual image data of the image acquisition device according to the spatial conversion relationship.

14. The unmanned aerial vehicle according to claim 13, further comprising a gimbal,
the gimbal being disposed on an abdomen of the body, and the detection radar and the image acquisition device being disposed on the gimbal;
wherein the flight controller is configured to obtain the pitch angle of the detection radar through an inclination angle of the gimbal.

15. The unmanned aerial vehicle according to claim 13, further comprising a height finder radar,
the height finder radar being disposed on the body and being configured to detect a ground height of the unmanned aerial vehicle;
wherein the flight controller is configured to obtain the ground height of the detection radar through the ground height of the unmanned aerial vehicle detected by the height finder radar.

16. A system, comprising:
a server, comprising at least one processor and a memory communicatively connected to the at least one processor, the memory storing instructions executable by the at least one processor; and
an unmanned aerial vehicle, comprising a flight controller, a detection radar and an image acquisition, the flight controller communicatively connected to the detection radar and the image acquisition device respectively;
wherein the server is communicatively connected to the unmanned aerial vehicle;
the flight controller is configured to obtain pose information of the detection radar, the pose information comprising a ground height of the detection radar and a pitch angle of the detection radar;
the at least one processor is configured to receive the pose information of the detection radar from the unmanned aerial vehicle; obtain a plurality of pieces of test coordinate data under the pose information of the detection radar; calculate and determine, through the test coordinate data, target calibration parameters in a preset spatial conversion function, wherein the preset spatial conversion function represents a spatial conversion relationship between the detection radar and the image acquisition device; and deliver the target calibration parameters to the unmanned aerial vehicle; and
the flight controller is further configured to receive the target calibration parameters from the server; determine the spatial conversion relationship between the detection radar and the image acquisition device based on the target calibration parameters; and perform data fusion between radar data of the detection radar and visual image data of the image acquisition device according to the spatial conversion relationship.

17. The unmanned aerial vehicle according to claim 16, wherein the spatial conversion relationship between the detection radar and the image acquisition device comprises:
a coordinate correspondence between radar detection data of a target and three-dimensional coordinates of the target in a detection radar coordinate system;
a first coordinate conversion relationship between the detection radar coordinate system and an image acquisition device coordinate system;
a second coordinate conversion relationship between the image acquisition device coordinate system and a two-dimensional image coordinate system; and
a third coordinate conversion relationship between the two-dimensional image coordinate system and a two-dimensional pixel coordinate system.

18. The system according to claim 16, wherein the unmanned aerial vehicle further comprises a body, the detection radar and the image acquisition device being disposed on the body;
one or more arms, connected to the body; and
one or more power apparatuses, disposed on the arms and configured to provide power for the unmanned aerial vehicle to fly.

19. The system according to claim 18, wherein the unmanned aerial vehicle further comprises a gimbal disposed on the body;
the detection radar and the image acquisition device are disposed on the gimbal; and
the flight controller is further configured to obtain the pitch angle of the detection radar through an inclination angle of the gimbal.

20. The system according to claim 18, wherein the unmanned aerial vehicle further comprises a height finder radar;
the height finder radar is disposed on the body and configured to detect a ground height of the unmanned aerial vehicle; and
the flight controller is further configured to obtain the ground height of the detection radar through the ground height of the unmanned aerial vehicle detected by the height finder radar.
